(19) United States
(12) Patent Application Publication
(10) Pub. No.: US 2013/0123005 A1
(43) Pub. Date: May 16, 2013

(54) ONLINE IMMERSIVE ENVIRONMENT AND WAGERING GAMES

(71) Applicants: Jeffrey L. Allen, Naperville, IL (US); Brian J. Barclay, Atlanta, GA (US); Jeremy M. Hornik, Chicago, IL (US); Larry J. Pacey, Northbrook, IL (US); Jamie W. Vann, Chicago, IL (US)

(72) Inventors: Jeffrey L. Allen, Naperville, IL (US); Brian J. Barclay, Atlanta, GA (US); Jeremy M. Hornik, Chicago, IL (US); Larry J. Pacey, Northbrook, IL (US); Jamie W. Vann, Chicago, IL (US)

(73) Assignee: WMS Gaming, Inc., Waukegan, IL (US)

(21) Appl. No.: 13/546,862

(22) Filed: Jul. 11, 2012

Related U.S. Application Data
(60) Provisional application No. 61/506,687, filed on Jul. 12, 2011.

(51) Int. Cl. A63F 13/12

(52) U.S. Cl. 463/29

(57) ABSTRACT

A method includes defining a number of locations in an online immersive environment, wherein each of the number of locations includes a number of games. The defining includes defining a rule set for a location. The rule set includes a rule that defines access to a game. The access to the game is based on game play of a different game. The method includes defining a number of paths between the number of locations in the online immersive environment, wherein the defining includes defining a rule for access to a path to travel between two locations. The method includes presenting a different game that is part of a location in the online immersive environment. The method includes enabling access to the game in the location, in response to determining that game play of the different game satisfies the rule that defines access to the game.

### RELATED APPLICATIONS

This application claims the priority benefit of U.S. Provisional Application Ser. No. 61/506,687 filed Jul. 12, 2011.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### FIELD

Embodiments of the inventive subject matter relate generally to wagering game systems, and more particularly to wagering game systems and an online immersive environment.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 depicts a system for providing an online immersive environment with wagering games, according to some example embodiments.

FIG. 2 depicts the online immersive environment of FIG. 1 after the player unlocks some of the content, according to some example embodiments.

FIG. 3 depicts a more detailed block diagram of two cities in an online immersive environment with wagering games, according to some example embodiments.

FIG. 4 depicts a system having an online immersive environment with wagering games that are associated with wagering games in wagering game establishments, according to some example embodiments.

FIG. 5 depicts a system having an online immersive environment wherein the wagering games therein are the wagering game machines in a wagering game establishment, according to some example embodiments.

FIG. 6 depicts a system having an online immersive environment wherein the wagering games therein are the wagering game machines in different wagering game establishments, according to some example embodiments.

FIG. 7 depicts a flowchart for providing an online immersive environment with wagering games, according to some example embodiments.

FIG. 8 is a block diagram illustrating a wagering game machine architecture, according to some example embodiments.

FIG. 9 is a block diagram illustrating a wagering game network 900, according to some example embodiments.

FIG. 10 is a perspective view of a wagering game machine, according to some example embodiments.

### DESCRIPTION OF THE EMBODIMENTS

This description of the embodiments is divided into six sections. The first section provides an introduction to some example embodiments, while the second section provides various system environments. The third section describes example operations performed by some example embodiments and the fourth section describes an example wagering game machine architecture and network environment. The fifth section describes an example wagering game machine and the sixth section presents some general comments.

### Introduction

This section provides an introduction to some example embodiments.

Some example embodiments provide an online immersive environment (e.g., a virtual world) having a number of cities, wherein one or more wagering games or non-wagering games can be played in the different cities by different players represented by avatars. For the description below, these different games in the different cities are described in reference to being wagering games. However, in some example embodiments, these games are non-wagering games. These games (whether wagering or non-wagering) can be associated with wagering games in a brick-and-mortar wagering game establishment (as further described below).

Examples of an online immersive environment can include online gaming (e.g., Role Playing Games (RPGs), virtual universes, etc.). Example online immersive environments can include computer-based simulated environments for its residents to traverse, inhabit, and interact through the use of avatars. Many online immersive environments are represented using three-dimensional graphics and landscapes. Also, these online immersive environments can be populated by many thousands of users, known as “residents.”

The online immersive environment can be part of some type of social network application. Therefore, some example embodiments create a wagering game play experience in a social environment. The online immersive environment can serve as an online market acquisition tool for attracting people who may ultimately be driven to wager at “real-life” (a.k.a. brick-and-mortar) wagering game establishments. Some example embodiments attempt to bring in persons to wager at wagering game establishments who typically will not otherwise. In the online environment, each city can have wagering games that when played can unlock different activities, games, items, access to other cities, etc. in the online immersive environment. Different wagering games can unlock different activities, games, items, access to other cities, etc. Accordingly, some example embodiments provide an online immersive environment that is unlocked over time, wherein game play therein attempts to drive persons to wager at wagering game establishments. The online immersive environment can also have different themes (medieval times, cruise lines where each city is a port of call, farm-based, etc.). Some example embodiments provide a social aspect whereby players achieve “status” as they progress further into the social game. A social environment is provided where players having similar interests can communicate, trade game assets, etc.

Embodiments are described in reference to cities being the location for grouping of wagering games in the online immersive environment. However, some example embodiments can define any type of area or region that will include grouping of one or more wagering games (as described herein). Examples include ports of call for various water bodies, townships, counties, states, countries, etc. The term city as used herein includes a collection of wagering games in an online immersive environment, wherein players that are residents of such city can play this collection of wagering games. The wagering games in the different cities can be online, wherein no monetary value is wagered.

In some of these embodiments, the wagering games associated with the different cities can be the same or a similar version of wagering games played at a wagering game establishment. For example, a wagering game (e.g., a slot machine) associated with a city in the online immersive environment can be a scaled-down version of a wagering game in a wagering game establishment. Accordingly, such embodiments can introduce persons that typically do not frequent a wagering game establishment to wagering games using a simpler, less intimidating version. Therefore, some example embodiments can potentially create a whole new segment of wagering game players that frequent wagering game establishments. The number of these simpler wagering games could then be added or increased within the wagering game establishments as these new players enter the wagering game establishments to occupy and wager on these wagering games.

In some example embodiments, the cities in the online immersive environment can be associated with a wagering game establishment or a related chain of wagering game establishments. For example, a city in the online immersive environment is associated with a wagering game establishment, wherein one or more wagering games (e.g., slot machines) are a part of the city. The cities can associated with different branding, type of game, etc. For example, city A can be associated with casino X, city B can be associated with casino Y, etc. In such a configuration, wagering games in given city in the online immersive environment can have wagering games that are the same or similar to the wagering games in the associated casino. In another example, city A can be associated with corporate brand X, city B can be associated with corporate brand Y, etc.

The online immersive environment can be configured such that the paths between cities are nonlinear. In particular, there can be multiple paths between city A and city K. In some example embodiments, each path between two different cities can have rules that define the requirements to travel the path in a given direction.

Some example embodiments include wagering games that are similar or the same in both the online immersive environment and the wagering game establishments. For example, the look-and-feel of a wagering game can be the same for both the online immersive environment and the wagering game establishment. For a given wagering game, the free wagering game play in the online immersive environment can have limited content, capabilities, features, in comparison to the pay-to-play game play in the wagering game establishments. Also, the pay-to-play game play in the wagering game establishments allows players to win real money, whereas the free wagering game play in the online immersive environment may not.

Also, some example embodiments provide an environment having wagering games having a low barrier to entry for persons that typically do not play wagering games. These wagering games can provide with simple game play. Wagering games in the different cities in the online immersive environment can leverage wagering games currently available in wagering game establishments. Accordingly, the system provides support for casual gaming and real wagering. Some example embodiments enable players to casually unlock content or purchase content in the online immersive environment. Players in the online immersive environment can interact with players at wagering game establishments.

In addition to having a range of games, a city can have a unique rule set that determine how games, content, etc. are unlocked, types of bonuses, establishment of different types of jackpots for the different games (e.g., progressives), etc. For example, city X can include wagering game A, wagering game B, and wagering game C with rule set M; city Y can include wagering game D, wagering game E, and wagering game F with rule set N, etc. The unique rule set can also determine a leader of the city (e.g., the mayor of the city). For example, a player can only be eligible to be the mayor if they have unlocked all games for the city, achieved certain levels for one or more games in the city, etc. A mayor can be based on a leader for game play (e.g., having the most points for all games, achieved the highest level for all games, achieved the highest level for a particular game, etc.). Cities can also have multiple leaderboards (e.g., biggest win overall, longest winning streak, best bonus round, etc.). In some example embodiments, any player who is on any of the leaderboards has the possibility of being chosen to be a mayor for the city. Mayors can be randomly chosen from among the leaderboards periodically (e.g., daily, weekly, monthly, etc.).

New features, charms, avatars, expansion cities, etc. can be launched on a periodic basis in the online immersive environment. In some example embodiments, players who have been mayor in a recent time period (e.g., last six months) are given early access to the expansion cities. This early access can act as a soft launch of the expansion cities. This early access can lasts for a short period (e.g., a few days, week, etc.) before the rest of the players are allowed access.

Some example embodiments enable the online immersive environment to grow over time such that new cities and games are added. Also, older cities can become unlocked for some or all players after the city has been in existence for a defined time (e.g., one year, six months, etc.). Once the online immersive environment matures (e.g., more cities, players, games, etc.), the cities can be separated into groups (e.g., nations, countries, etc.). In some example embodiments, a mirrored-version of all the cities is created (effectively doubling the number of cities, but not the number of games). The players can then be divided into two or more nations based on the different mirrored-versions of the cities. These configurations create an online immersive environment that is based on more head-to-head competitions and tournaments.

Therefore, players can pursue unlocking the entire online immersive environment (including each city, each game in each city, various achievements in the different games, etc.). Some example embodiments can incorporate various aspects of online social applications. For example, players can chat with other players across the entire online immersive environment, within each city, within each game, etc. Players can play tournaments together in team play, against each other in head-to-head competition, etc. In some example embodiments, there can be periodic city v. city tournaments based on wagering game play among the players in the two cities. For example, wagering game play in one city can be compared to wagering game play in a different city to determine a winner. In some example embodiments, there can be multiple factions of people in the online immersive environment that are above a city affiliation. For example, the factions can be based on political affiliations, races, etc. In some example embodiments, a city affiliation is defined to be in one of these factions. For example, the city affiliation can be based on the mayor's affiliation. In some example embodiments, there can be player v. player challenges. The players in the challenge can be from a same or different city. For example, wagering game play by one player can be compared to wagering game play by the other player to determine a winner. The players can offer up accessories, currency, etc., wherein the winner keeps what was offered as part of the challenge.

While described such that the wagering games in the online immersive environment are separate from the wagering game establishments, in some example embodiments, the online immersive environment can within a wagering game establishment or across multiple wagering game establishments. In such a configuration, the wagering games for the different cities can be the wagering games in the wagering game establishments (instead of online versions of the wagering games). In some example embodiments, the game play for the wagering games in the online immersive environment can affect the game play for the wagering games in the wagering game establishments. For example, reaching certain levels for the wagering games in the online immersive environment can unlock content or levels, increase bonuses, etc. for the wagering games in the wagering game establishments. In some example embodiments, unlocking of content in the online immersive environment can require some type of social interaction. For example, to unlock the path from city X to city Y, the player is required to invite 10 people that are currently not players to play in the online immersive environment. Unlocking of content in the online immersive environment can also require interaction with real world product or services.

In some example embodiments, play at the wagering game establishment can affect play in the online immersive environment and vice versa. This affect may or may not be in real time. For example, unlocking content in the online immersive environment can require a number of players involved in a given activity in the online immersive environment to exceed a threshold. For example, 10,000 players are required to play a wagering game in city X prior to allowing access by any player into city Y. Similarly, unlocking content for a wagering game at the wagering game establishment can require a number of players involved in a given activity in the online immersive environment to exceed a threshold. In another example, activity by certain players in the online immersive environment by a certain group of players can unlock content in a wagering game at the wagering game establishment. In some example embodiments, each city in the online immersive environment can have different stores with different items. The items sold in a store in one city can be needed in a different city. For example, item X is only sold in a store in city M and is needed to unlock content in city B.

### System Environment

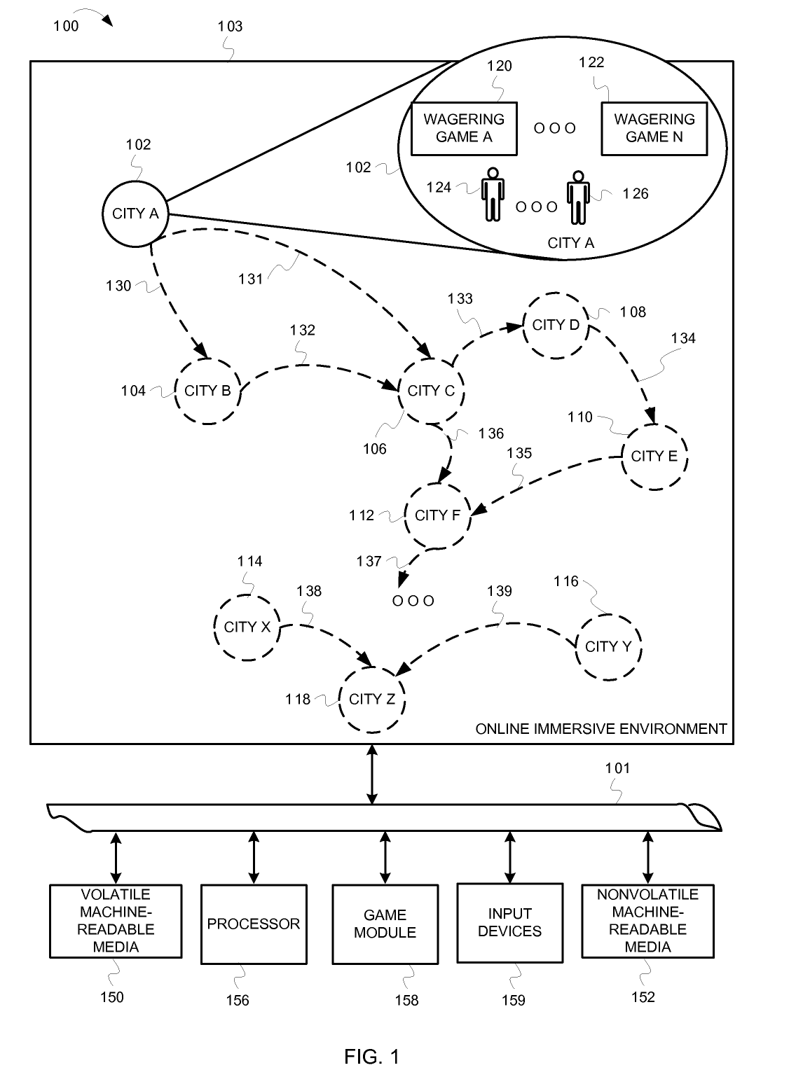

This section describes example system environments and presents structural aspects of some embodiments. This section includes example systems for an online immersive environment and associated wagering games. This section will discuss FIGS. 1-6.

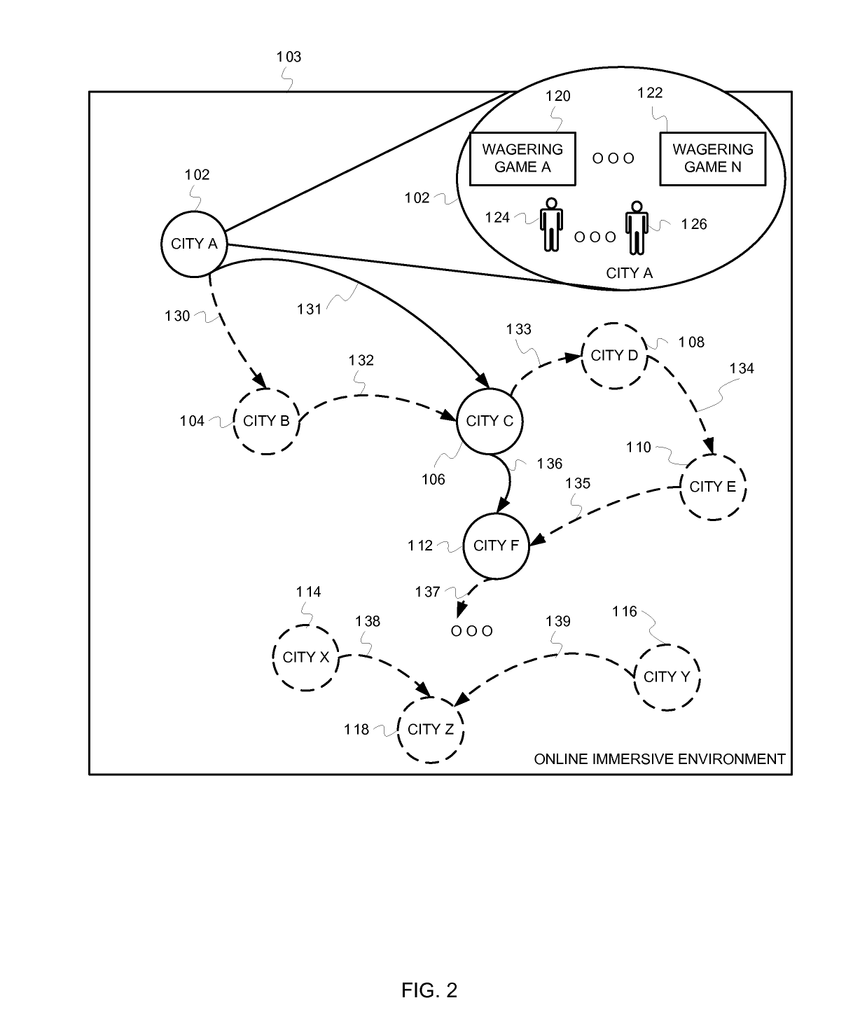

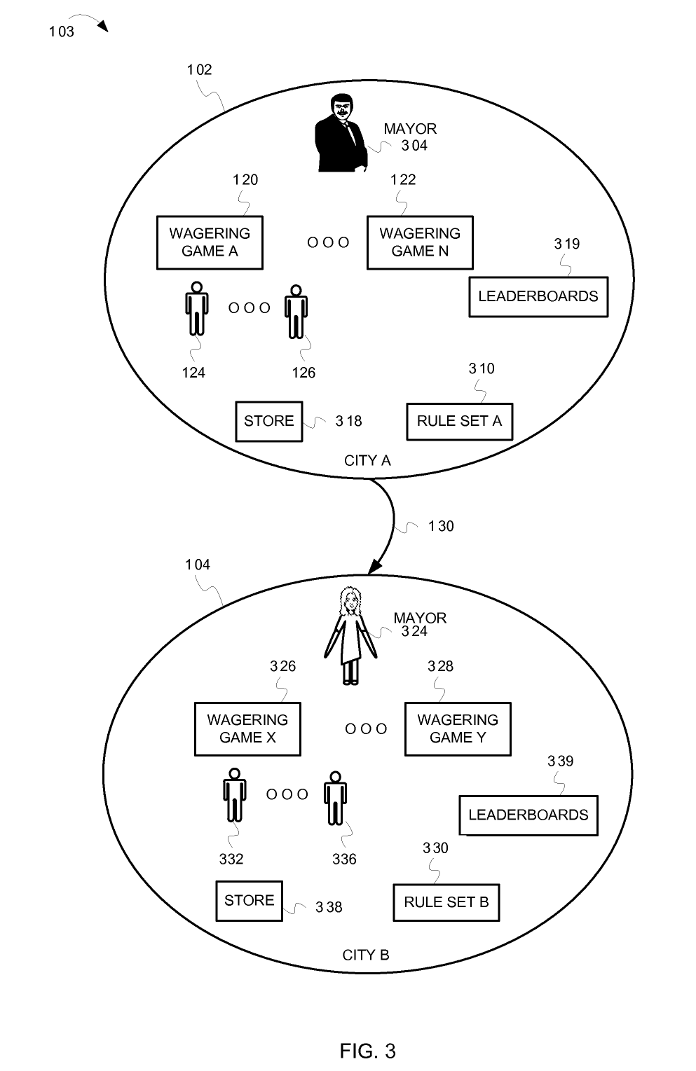

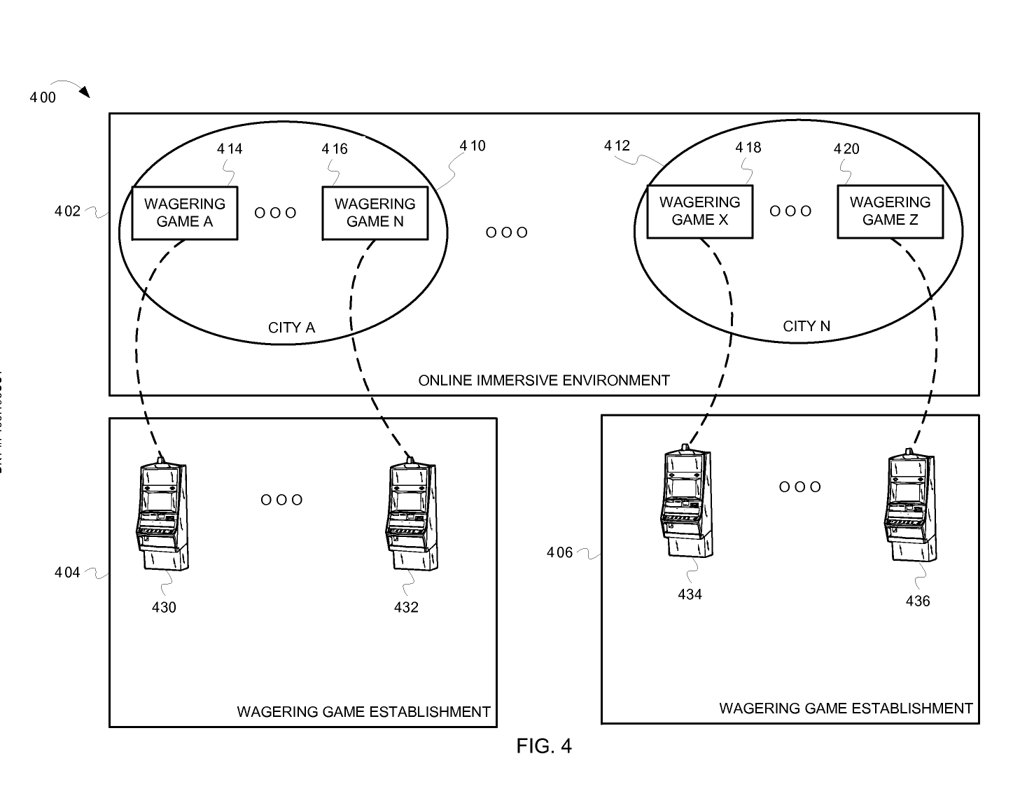

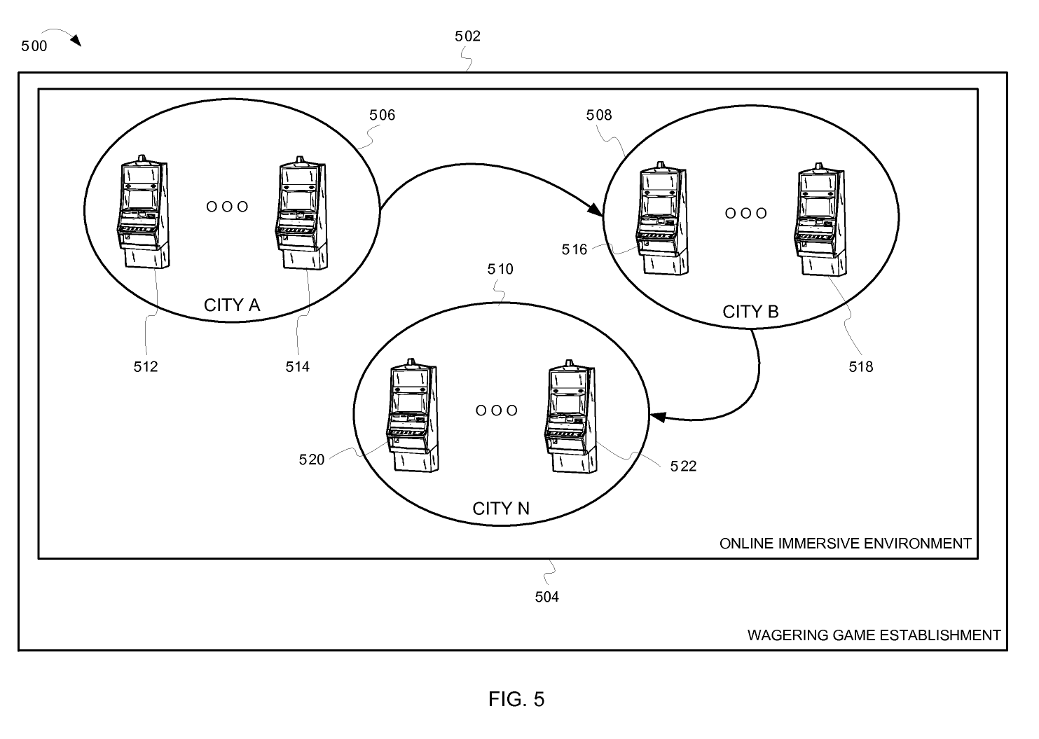

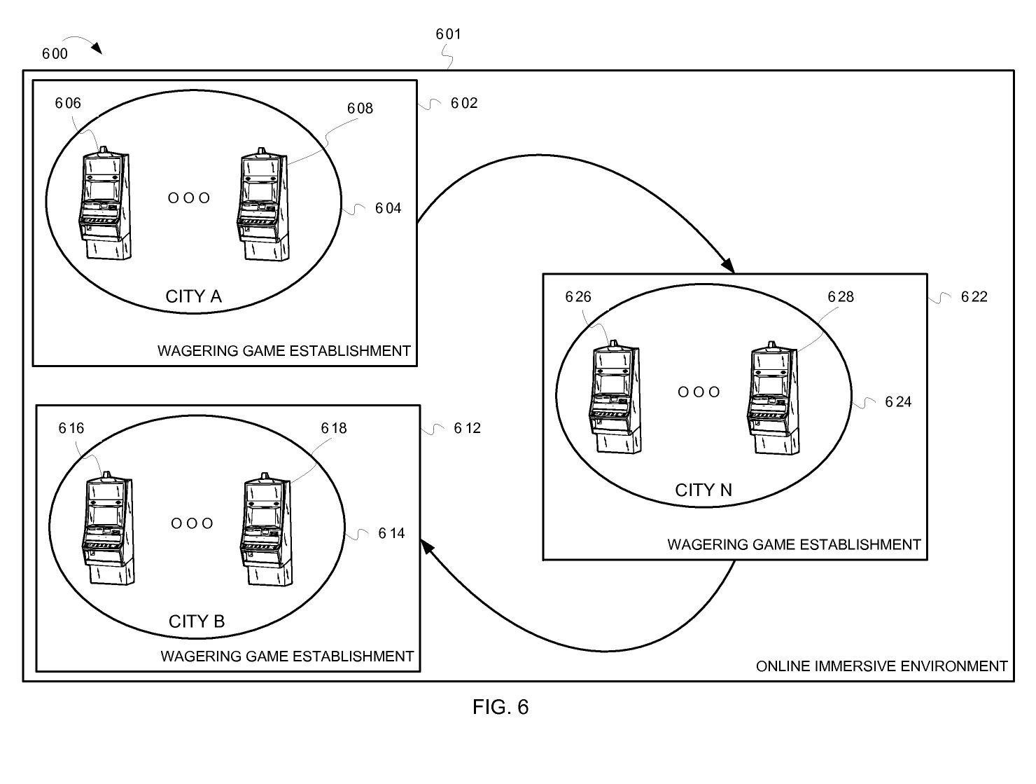

The discussion of FIG. 1 will describe a system that provides an online immersive environment with wagering games. The discussion of FIG. 2 will describe the system of FIG. 1 after a player has unlocked some cities and paths in the online immersive environment. The discussion of FIG. 3 will describe more details regarding different components of a city in the online immersive environment. The discussion of FIG. 4 will describe a system having an online immersive environment with wagering games that are associated with wagering games in wagering game establishments. The discussion of FIGS. 5-6 will describe a system having an online immersive environment wherein the wagering games therein are the wagering game machines in wagering game establishment(s).

FIG. 1 depicts a system for providing an online immersive environment with wagering games, according to some example embodiments. FIG. 1 depicts system 100 that includes a display of a part of an online immersive environment 103, a processor 156, a game module 158, input devices 159, volatile machine-readable media 150, and nonvolatile machine-readable media 152 that are communicatively coupled together through bus 101. FIG. 1 can represent any type of computing device (e.g., a desktop computer, laptop computer, mobile device, etc.). Also the components of FIG. 1 can be in a single device or distributed across two or more devices. For example, some or all of the operations of the game module 158 can be performed at a server device and the display of the online immersive environment 103 can be performed on a client device that is communicatively coupled to the server device.

The processor 156 can be one processor or possibly multiple processors, multiple cores, multiple nodes, and/or implementing multi-threading, etc. The volatile machine-readable media 150 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. Although illustrated as being coupled to the bus 101, the volatile machine-readable media 150 may be directly coupled to the processor 156. The nonvolatile machine-readable media 152 can include optical storage, magnetic storage, etc. The input device(s) 159 can include a touchscreen of the screen 103, a keyboard, mouse, microphone, etc. The system 100 can include other components not shown in FIG. 1. For example, the system 100 can include a network interface (e.g., an ATM interface, an Ethernet interface, a Frame Relay interface, SONET interface, wireless interface, etc.).

Game module 158 can be software, firmware, hardware or a combination thereof. For example, the game module 158 can be software that is loaded into the processor 156 for execution therein. As further described below, the game module 158 can enable access to the online immersive environment by the players based on player login, present wagering games for play in the different cities to the different players, authorize access by players to different cities, games, paths, etc.

To illustrate, the display of a part of the online immersive environment 103 is shown. The online immersive environment 103 includes a number of cities—a city A 102, a city B 104, a city C 106, a city D 108, a city E 110, a city F 112, a city X 114, a city Y 116, and a city Z 118. The online immersive environment 103 also includes a number of paths between the cities. The city A 102 is connected to the city B 104 through a path 130. The city A 102 is also connected to the city C through a path 131. The city B 104 is connected to the city C through a path 132. The city C 106 is connected to the city D 108 through a path 133. The city D 108 is connected to city D 110 through a path 134. The city E 110 is connected to the city F 112 through a path 135. The city C 106 is also connected to the city F 112 through a path 136. The city F 112 includes a path 137 outward to locations that connected to the city X 114 and the city Y 116. The city X 114 is connected to the city Z 118 through a path 138. The city Y 116 is connected to the city Z 118 through a path 139. As shown, the online immersive environment is configured such that the paths between cities are nonlinear. There can be multiple ways to reach a same destination. For example, the city F 112 can be reached from the city C 106 through the direct path 136 and through the path 133 (through the city D 108), the path 134 (through the city E 110) and then through the path 135.

FIG. 1 also shows an expanded view of the city A 102 as an example. A more detailed description of cities in an online immersive environment is described in reference to FIG. 3, set forth below. As shown, the city A 102 includes a number of wagering games—shown as a wagering game A 120 through a wagering game N 122. The city A 102 also includes a number of players that are resident therein—shown as a player 124 and a player 126. In the online immersive environment, the players can appear as avatars. Each of the cities in the online immersive environment 103 can have a number of wagering games and resident players therein.

In this example, when the player begins in the online immersive environment 103, the player starts in the city A 102. For example, the player can be given access to one of the wagering games in the city A 102 (e.g., the wagering game A 120). After achieving certain thresholds of game play, other wagering games in the city A 102 can be unlocked, the path 130 to the city B 104 can be unlocked, the path 131 to the city C 106 can be unlocked, etc. Because this is the start of play in the online immersive environment 103, the other cities and paths thereto are initially locked (shown with dashed lines). Also, the arrows for the paths between cities indicate the next possible location in the online immersive environment. For example, after game play in the city A 102, the player can advance to the city B 104 along the path 130 or the city C 106 along the path 131.

Each player can have an account that is used to access the online immersive environment 103. The player account for the online immersive environment 103 for a player is associated with their player account for one or more wagering game establishments. Alternatively, the player account for the online immersive environment 103 can be the same player account for one or more wagering game establishments.

FIG. 2 depicts the online immersive environment of FIG. 1 after the player unlocks some of the content, according to some example embodiments. In particular, FIG. 2 depicts the online immersive environment 103 of FIG. 1, after the player unlocked and traversed the path 131 to the city C 106 and unlocked and traversed the path 136 to the city F 112. Accordingly, the player had performed some operations (e.g., advanced above a certain threshold in one more wagering games in the city A 102) defined by the rule set for the path 131 to unlock the path 131 to advance to the city C 106. Similarly, the player had performed some operations (e.g., advanced above a certain threshold in one more wagering games in the city C 106) defined by the rule set for the path 136 to unlock the path 136 to advance to the city F 112. In this example, the other cities and paths in the online immersive environment 103 remained locked and inaccessible. Also, the player can advance back from the city F 112 to the city C 106 and from the city C 106 to the city A 102. The player can return to previous cities to play the wagering games therein, buy items from a store in the specific city, etc.

In some example embodiments, each path between two different cities can have rules that define the requirements to travel the path in a given direction. For example, traveling the path 130 from the city A 102 to the city B 104 requires that the player achieve achievement N (e.g., a win that is at least 20 times the bet) in the wagering game A 120 in the city A 102.

Players can also have at least two different currencies in the online immersive environment 103. A first currency includes a bankroll that includes allowance credits. In particular, players can be given a number of allowance credits periodically for game play, purchases of items in the stores, etc. A second currency includes funding that is collected over time and that is a result of game play. Funding can be used to purchase charms for player avatars, purchase city enhancements while a player is a mayor of a city, etc.

In some example embodiments, within a city, a player can select which game to start. Based on game play of the selected game, the player can then earn the right to unlock the additional wagering games in the city. In particular, a player can unlock a wagering game after a given threshold is achieved for another wagering game (e.g., triggering a bonus, obtaining a big win, obtaining a five of a kind, etc.). The player can then purchase with either or both of the currencies provided to the player in the online immersive environment.

FIG. 3 depicts a more detailed block diagram of two cities in an online immersive environment with wagering games, according to some example embodiments. In this example, the city A 102 is connected by the path 130 to the city B 104. As shown, each city can have its own wagering games, leaderboards, store and rule set. Each of the wagering games, leaderboards, store and rule set can be unique for that city. The city A 102 includes a number of wagering games (shown as the wagering game A 120 and the wagering game N 122), leaderboards 319, a store 318, a rule set A 310, a number of resident players (shown as the player 124 and the player 126), and a mayor 304 (that is selected from among resident players of the city A 302). The city B 104 includes a number of wagering games (shown as a wagering game X 326 and a wagering game Y 328), leaderboards 339, a store 338, a rule set N 330, a number of resident players (shown as a player 332 and a player 336), and a mayor 324 (that is selected from among resident players of the city B 104).

In some example embodiments, the wagering games in the different cities can be online, wherein no monetary value is wagered. In some example embodiments, the wagering games associated with the different cities can be the same or a similar version of wagering games played at a wagering game establishment. For example, a wagering game (e.g., a slot machine) associated with a city in the online immersive environment can be a scaled-down version of a wagering game in a wagering game establishment. Accordingly, such embodiments can introduce persons that typically do not frequent a wagering game establishment to wagering games using a simpler, less intimidating version. Therefore, some example embodiments can potentially create a whole new segment of wagering game players that frequent wagering game establishments. In some example embodiments, the simpler wagering games are used in some or all of the cities to provide less intimidating wagering games to persons who have not previously played wagering games. For example, a three reel, single win line slot machine can be used. In some configurations, the wagering games in the beginning cities are the simplest, wherein the wagering games can become increasing complex in cities that are subsequently unlocked in the online immersive environment. The number of these simpler wagering games could then be added or increased within the wagering game establishments as these new players enter the wagering game establishments to occupy and wager on these wagering games.

In some example embodiments, the cities in the online immersive environment 103 can be associated with a wagering game establishment or a related chain of wagering game establishments. For example, a city in the online immersive environment is associated with a wagering game establishment, wherein one or more wagering games (e.g., slot machines) are a part of the city. The cities can associated with different branding, type of game, etc. For example, the city A 102 can be associated with casino X, the city B 104 can be associated with casino Y, etc. In such a configuration, wagering games in given city in the online immersive environment can have wagering games that are the same or similar to the wagering games in the associated casino. In another example, the city A 102 can be associated with corporate brand X, the city B 104 can be associated with corporate brand Y, etc. The pay tables between the wagering games in the online immersive environment 103 and the wagering games in the wagering game establishment can be different. For example, to achieve a certain level for a same wagering game in the online immersive environment 103 500 plays can be required, whereas in the wagering game establishment only 50 plays are typically required. The look-and-feel of a wagering game can be the same for both the online immersive environment 103 and the wagering game establishment. For a given wagering game, the free wagering game play in the online immersive environment 103 can have limited content, capabilities, features, in comparison to the pay-to-play game play in the wagering game establishments. Also, the pay-to-play game play in the wagering game establishments allows players to win real money, whereas the free wagering game play in the online immersive environment 103 may not.

In some examples, special events can occur that awards credits if a player is actively playing during the event in a city. Such an event can be random or specially advertised. Additional games in the city can be unlocked through a range of mechanics. For example, a player can purchase a group of games with bankroll currency or funding currency. Games can also be unlocked based on a rule set. For example, game achievements for games that are currently unlocked can unlock additional games. Accordingly, there can be a range of paths that allow each player's experience to be unique based on whether cities and games therein are unlocked and the order of such unlocking

The unique rule set can also determine a leader of the city (e.g., the mayor of the city). In particular, the rule set A 310 can determine the criteria for selecting a mayor for the city A 102, and the rule set N 330 can determine the criteria for selecting a mayor for the city B 104. For example, a player can only be eligible to be the mayor if they have unlocked all games for the city, achieved certain levels for one or more games in the city, etc. A mayor can be based on a leader for game play (e.g., having the most points for all games, achieved the highest level for all games, achieved the highest level for a particular game, etc.). The mayor can be set for a given time period (e.g., one day, one week, etc.). For example, the mayor 304 may be mayor for one week of the city A 102, while the mayor 324 may be mayor for three days of the city B 104. After expiration of the time period, a new mayor is selected based on the unique rule set for the city. In some example embodiments, the mayor can define or adjust rules for the rule set for the city. The mayor of the city can also trigger events or allocate trophies or in-game prizes. The mayor can create tournaments of games in the city, special leaderboards, etc. Cities can also have multiple leaderboards (e.g., biggest win overall, longest winning streak, best bonus round, etc.). The rule sets can define the number and type of leaderboards. In particular, the rule set A 310 would define the number and type of leaderboards 319 in the city A 102, and the rule set N 330 would define the number and type of leaderboards 339 in the city B 104. In some example embodiments, any player who is on any of the leaderboards has the possibility of being chosen to be a mayor for the city. Mayors can be randomly chosen from among the leaderboards periodically (e.g., daily, weekly, monthly, etc.). Also, mayors can be notified that they have been selected and the time period when their mayorship is active.

Mayors can be given a funding currency bonus that can be used to spend on city bonuses that apply to every player who plays wagering games in the city. Examples of city bonuses can include tchotchkes from a store in the city, activating large mystery-triggered progressives in one or more wagering games in the city, etc. The mayor can also play the wagering games from their funding currency. Accordingly, the mayor can spend their funding currency on city bonuses or the wagering games.

In some example embodiments, a mayor can earn currency based on players in their city, game play in their city, etc. For example, assume that there are 500 players in the city A 102, wherein these players earned $2850 in bankroll currency during mayorship of the mayor 304. The mayor 304 would earn a bonus of $2850, plus $1 for each player ($500) in funding currency. This funding currency can be used during current or future mayorships of the player to spend on city bonuses, etc. for the city A 102.

In some example embodiments, if a player is a top mayor for a given time period (e.g., day, week, month, etc.) for the online immersive environment 103, the player can receive additional bonuses, extend the current mayorship, receive another mayorship for the same or different city, etc. Players (including the mayor) can receive bonuses for bringing other players into their city for game play. In some example embodiments, the mayor can receive a greater bonus for bringing other players into their city for game play. Cities can also have mayoral leaderboards.

For example, the leaderboards 319 and the leaderboards 339 can include mayoral leaderboards for their cities. Example mayoral leaderboards can include best mayor, longest mayorship, most days as mayor, most cities mayored, etc. In some example embodiments, a mayor of a city can be given a key to access their city. The mayor can give this key to a player that will allow the player access the city without requiring the player to unlock all of the previous cities. With reference to FIG. 1 to illustrate, the mayor of the city D 108 can give a key to a player that just started play (beginning in the city A 102). Accordingly, this player can become a resident player of the city D 108 without unlocking the path 131, the city C 106, and the path 133.

New features, charms, avatars, expansion cities, etc. can be launched on a periodic basis in the online immersive environment 103. In some example embodiments, players who have been mayor in a recent time period (e.g., last six months) are given early access to the expansion cities. This early access can act as a soft launch of the expansion cities. This early access can lasts for a short period (e.g., a few days, week, etc.) before the rest of the players are allowed access.

Each game for a city can have a set of trophies that can be won. For example, the trophies can include game token awards (e.g., bronze, silver, gold, an easter egg (diamond), etc.). To unlock a city and/or games therein a player can be required to purchase a key based on multiple game currencies. For example with reference to FIG. 1, the city B 104 can require a player to spend a gold token and two silver game tokens to obtain a key for access thereto, while the city F 112 can require a player to spend three gold tokens to obtain a key for access thereto. As an alternative for access, a player can use one of the game currencies. For example, instead of game tokens, the city B 104 can be accessed by the player using 10,000 credits of funding currency. Other cities can require a specific token from a specific game or have the player achieve a certain level or accomplishment from a specific game or city. For example, the city E 110 can require the player to obtain a gold level for all games in the city D 108 prior to access. In some example embodiments, player can gift game tokens to other players to help the other players unlock cities, games, etc.

In some example embodiments, play at the wagering game establishment can affect play in the online immersive environment and vice versa. This affect may or may not be in real time. For example, unlocking content in the online immersive environment 402 can require a number of players involved in a given activity in the online immersive environment to exceed a threshold. For example, 10,000 players are required to play a wagering game in city X prior to allowing access by any player into city Y. Similarly, unlocking content for a wagering game at the wagering game establishment can require a number of players involved in a given activity in the online immersive environment 402 to exceed a threshold. For example, 500,000 players are required to play a wagering game in city A prior to allowing access to certain content for a wagering game at the wagering game establishment (e.g., additional bonuses, better pay tables, etc.).

In another example, activity by certain players in the online immersive environment 402 by a certain group of players can unlock content in a wagering game at the wagering game establishment. To illustrate, in response to players (who are “friends” of player A in the online immersive environment) achieving a certain status, obtaining certain charms, etc. in a wagering game in the online immersive environment 402, player A is able to access certain games, content, etc. at the wagering game establishment 404/406. In some example embodiments, activity at a wagering game by a player at the wagering game establishment 404/406 can affect game play of players in the online immersive environment 402. For example, assume that player A is currently considered a resident of city N in the online immersive environment 402 but is offline and playing a wagering game at the wagering game establishment 406. In response to player A achieving a certain status, goal, etc. at a wagering game 434 at the wagering game establishment 406, certain content, is unlocked for wagering games of the city N 412. For example, the players that are residents of the city N 412 receive better pay tables, increased bonusing, etc. for a defined time period (e.g. one hour) for play of a wagering game in the city N 412.

Therefore, players can pursue unlocking the entire online immersive environment 103 (including each city, each game in each city, various achievements in the different games, etc.). Some example embodiments can incorporate various aspects of online social applications. For example, players can chat with other players across the entire online immersive environment 103, within each city, within each game, etc. Players can play tournaments together in team play, against each other in head-to-head competition, etc.

In some example embodiments, players can select an avatar to represent them in the online immersive environment 103. For example, the players can select from “lucky avatars” (e.g., rabbit, leprechaun, lemming, meerkat, penguin, etc.). Also, players can pay for customizable accessories (e.g., hats, t-shirts, shoes, tattoos, etc.) for their avatar. These customizable accessories can be paid for by one or both of their game currencies. Also, the different stores in the different cities can have different items, customizable accessories, etc.

Avatars can also be visually enhanced to show the player's hot or cold streak. For example if the player wins X number of times during a defined time period, the player is on a hot streak. If the player loses X number of times during a defined time period, the player is on a cold streak. Hot streaks can lead to additional enhancements (e.g., bonus triggers with only two bonus triggers, free spins double, big wins double, etc.). These can be temporary enhancements that expire after a defined period after the avatar is no longer on a hot streak.

Players can also reach levels where charms can be added to their avatar. These charms can have various effects wherein the effects can continue for a given number for days, game playing sessions, uses, etc. These charms can be purchased or earned by the player. Effects can include increase in win percentages, bonus percentages, etc.

In some example embodiments, there can be periodic city v. city tournaments based on wagering game play among the players in the two cities. For example, wagering game play in the city X 114 can be compared to wagering game play in the city Y 116 to determine a winner. The winning players, city, etc. can receive a bonus. In some example embodiments, players cannot change cities once they commit to a city during a tournament.

In some example embodiments, there can be multiple factions of people in the online immersive environment 103 that are above a city affiliation. For example, the factions can be based on political affiliations, races, etc. In some example embodiments, a city affiliation is defined to be in one of these factions. For example, the city affiliation can be based on the mayor's affiliation. To illustrate, assume the factions are based on political affiliations. The city affiliation can be then be tied to the political affiliation of the current mayor. For example, the city affiliation of the city A 102 is based on the political affiliation of the mayor 304, and the city affiliation of the city B 104 is based on the political affiliation of the mayor 324. In some example embodiments, the online immersive environment 103 can create a mirror of the cities for each faction. For example, faction A would have the city A 102, the city B 104, the city C 106, the city D 108, the city E 110, the city F 112, the city X 114, the city Y 116, and the city Z 118. Faction B would have its own set of the same cities—the city A 102, the city B 104, the city C 106, the city D 108, the city E 110, the city F 112, the city X 114, the city Y 116, and the city Z 118.

In some example embodiments, there can be player v. player challenges. The players in the challenge can be from a same or different city. For example, wagering game play by the player 124 in the city A 102 can be compared to wagering game play by the player 332 in the city B 104 to determine a winner. The players can offer up accessories, currency, etc., wherein the winner keeps what was offered as part of the challenge.

Some example embodiments can require that players return to play previously played wagering games in previously unlocked cities to unlock additional content, items, etc. that are needed in a current city. In particular, this additional content, items, etc. may not be available to be unlocked until the current city is reached. Accordingly, players can be required to return to play previously played wagering games in the online immersive environment.

In some example embodiments, unlocking of content in the online immersive environment 103 can require some type of social interaction. For example, to unlock the path 133 from the city C 106 to the city D 108, the player is required to invite 10 people that are currently not players to play in the online immersive environment 103. Unlocking of content in the online immersive environment 103 can also require interaction with real world product or services. For example, to unlock the path 136 from the city C to city F, the player is required to scan the bar code of product A using some type of bar code scanning device that is communicatively coupled to the player's account in the online immersive environment 103. In another example, to unlock a wagering game, the player is required to visit a wagering game establishment and checking in using their mobile device.

In some example embodiments, each city in the online immersive environment 103 can have different stores with different items. The items sold in a store in one city can be needed in a different city. For example, item X is only sold in a store in the city F 112 and is needed to unlock content in the city B 104. Accordingly, a player is required to access the city F 112 and then return to the city B 104 to use item X. Also, obtaining these items in these different stores in the online immersive environment 103 can unlock wagering games, content for wagering games, etc. at a wagering game establishment. For example, in response to a player obtaining item X from the city E 110 and item Y from the city Z 118, the player has unlocked content at a wagering game at a wagering game establishment.

Also, items sold in a store in one city can have a higher currency in a different city. For example, a player can obtain items H in the city C 106 and travel to the city X 114. In the city X 114, items H are worth more. Accordingly, the player can exchange items H for other items in store X. Also, because items H are worth more in the city X 114, the player can play more wagering games in the city X 114 than if the player were to use items H to play wagering games in the city C 106 (where the items H were originally bought). In some example embodiments, different wagering games in different cities can require different items purchased at the stores for game play. For example, wagering game A in the city A 102 can require item A (which can be purchased in a store in the city A 102); wagering game B in the city B 104 can require item X (which can be purchased in a stored in the city X 114), etc. In some example embodiments, the wagering games in different cities can accept different types of items purchased at the stores for game play. However, the number of items for game play can differ based on the type of item. For example, wagering game H in the city D 108 can be require 20 items H and only one of item A.

In some example embodiments, players can gift items from the stores, currencies, certain advantageous plays for a wagering game, etc. to other players. For example, player A can have a spin that includes additional bonus triggers on the reels as part of a slot wagering game. Player A can gift these spin to other players. If the other players win a bonus from this spin when they play, the bonus is returned to the player A.

While described such that the wagering games in the online immersive environment are separate from the wagering game establishments, in some example embodiments, the wagering games in the online immersive environment are associated with wagering game machines in one or more wagering game establishments. In such a configuration, the wagering game play in the online immersive environment can affect the wagering game play in the wagering game establishment and vice versa. There can be a one-to-one relationship between a city in the online immersive environment and a wagering game establishment. Alternatively, multiple cities or all of the cities can be associated with a same wagering game establishment.

To illustrate, FIG. 4 depicts a system having an online immersive environment with wagering games that are associated with wagering games in wagering game establishments, according to some example embodiments. FIG. 4 depicts a system 400 that includes an online immersive environment 402, a wagering game establishment 404 and a wagering game establishment 406. As described above, the online immersive environment shown in FIG. 4 can be the display output from an application executing on a server and processing the operations for enabling game play therein.

The online immersive environment 402 includes a number of cities (shown as a city A 410 and a city N 412). The city A 410 includes a number of wagering games (shown as a wagering game A 414 and a wagering game N 416. The city N 412 includes a number of wagering games (shown as a wagering game X 418 and a wagering game Z 420). The wagering game establishment 404 includes a number of wagering game machines (shown as a wagering game machine 430 and a wagering game machine 432). The wagering game establishment 406 includes a number of wagering game machines (shown as a wagering game machine 434 and a wagering game machine 436).

In this example, there is an association between a wagering game in the online immersive environment 402 and one of the wagering game machines in one of the wagering game establishments 404 and 406. The wagering game A 414 in the online immersive environment 402 is associated with the wagering game machine 430 in the wagering game establishment 404. The wagering game N 416 in the online immersive environment 402 is associated with the wagering game machine 432 in the wagering game establishment 404. The wagering game X 418 in the online immersive environment 402 is associated with the wagering game machine 434 in the wagering game establishment 406. The wagering game Z 420 in the online immersive environment 402 is associated with the wagering game machine 436 in the wagering game establishment 406. The association between the wagering game in the online immersive environment and the wagering game machine in a wagering game establishment can vary. For example, the wagering game in the online immersive environment can be a simpler version of the same game being provided by the wagering game machine.

In some example embodiments, the game play for the wagering games in the online immersive environment can affect the game play for the wagering games in the wagering game establishments. For example, reaching certain levels for the wagering games in the online immersive environment can unlock content or levels, increase bonuses, etc. for the wagering games in the wagering game establishments. In some example embodiments for a given wagering game, achieving certain levels in the online immersive environment can unlock this simpler version for wagering game play at the wagering game establishment (instead of being required to play a more complex version that is typically provided for the wagering game at the wagering game establishment). For example, the cost to play the simpler version can be less, the number of lines, reels, etc. can be less in the simpler version, etc.

Players can accumulate points for game play in the online immersive environment 402, independent of whether they win. Some or all of the cities can include a store to enable players to exchange their points, currencies, etc. for unlocking content in wagering games in the online immersive environment 402 or wagering games in one of the wagering game establishment 404 and 406. In some example embodiments, the points and currency can be converted to credits at the wagering game establishment, unlocking of content for wagering games at the wagering game establishment. The points and currency can also be converted to coupons, discounted or free products, etc. in the real world.

While described such that the wagering games in the online immersive environment are separate from the wagering game establishments, in some example embodiments, the wagering games of the online immersive environment are the wagering game machines at the wagering game establishments. In some example embodiments, the wagering games for the online immersive environment are within a same wagering game establishment. To illustrate, FIG. 5 depicts a system having an online immersive environment wherein the wagering games therein are the wagering game machines in a wagering game establishment, according to some example embodiments. In such a configuration, the wagering games for the different cities can be the wagering games in the wagering game establishments (instead of online versions of the wagering games).

FIG. 5 depicts a system 500 that includes a wagering game establishment 502 and an online immersive environment 504. In this example, some or all of the wagering game machines in the wagering game establishment are associated with the cities in the online immersive environment 504. For example, a bank of wagering game machines in the wagering game establishment 502 can be the wagering games for a city in the online immersive environment 504. A city A 506 includes a first group of wagering game machines in the wagering game establishment 502 (shown as a wagering game machine 512 and a wagering game machine 514). A city B 508 includes a second group of wagering game machines in the wagering game establishment 502 (shown as a wagering game machine 516 and a wagering game machine 518). A city N 510 includes a third group of wagering game machines in the wagering game establishment 502 (shown as a wagering game machine 520 and a wagering game machine 522). Although not shown, each of the cities can also include players, leaderboards, rule set, and a mayor (as shown in FIG. 3).

As an alternative to the system 500 of FIG. 5, some example embodiments provide a configuration where each city in the online immersive environment is within a different wagering game establishment. To illustrate, FIG. 6 depicts a system having an online immersive environment wherein the wagering games therein are the wagering game machines in different wagering game establishments, according to some example embodiments. In such a configuration, the wagering games for the different cities can be the wagering games in different wagering game establishments (instead of online versions of the wagering games).

FIG. 6 depicts a system 600 that includes an online immersive environment 601. The cities of the online immersive environment 601 are in different wagering game establishments (a wagering game establishment 602, a wagering game establishment 612, and a wagering game establishment 622). A city A 604 includes a group of wagering game machines in the wagering game establishment 602 (shown as a wagering game machine 606 and a wagering game machine 608). A city B 614 includes a group of wagering game machines in the wagering game establishment 612 (shown as a wagering game machine 616 and a wagering game machine 618). A city N 624 includes a group of wagering game machines in the wagering game establishment 622 (shown as a wagering game machine 626 and a wagering game machine 628). Although not shown, each of the cities can also include players, leaderboards, rule set, and a mayor (as shown in FIG. 3).

### Example Operations

This section describes operations associated with some example embodiments. In the discussion below, the flowcharts will be described with reference to the block diagrams presented above. However, in some example embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some example embodiments, the operations can be performed in series, while in other embodiments, one or more of the operations can be performed in parallel. Moreover, some embodiments can perform less than all the operations shown in any flowchart.

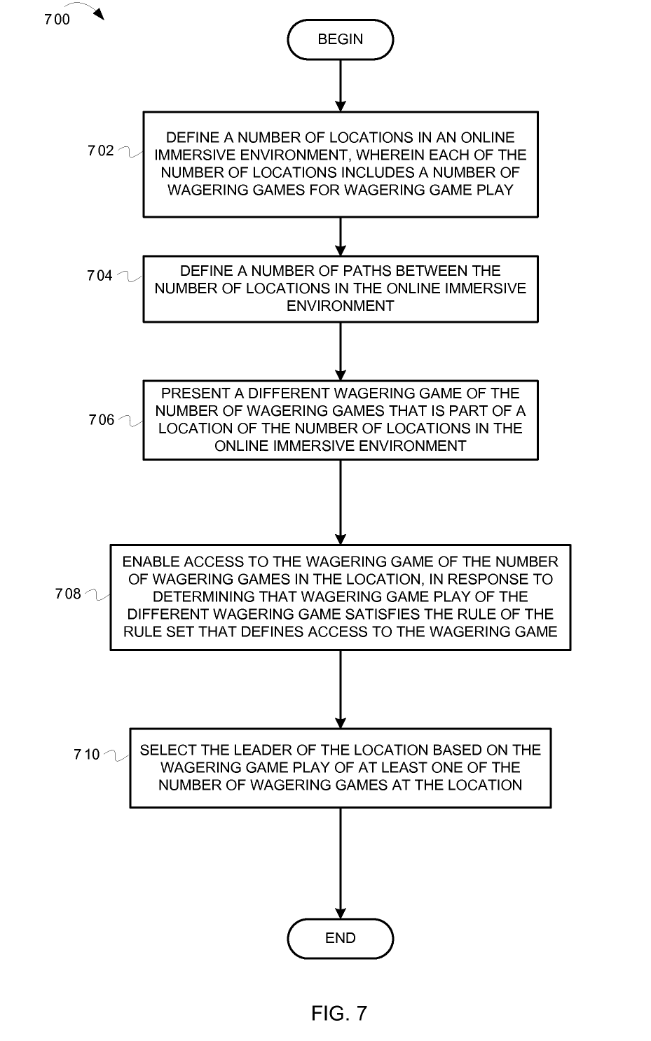

The section will discuss FIG. 7. FIG. 7 depicts a flowchart for providing an online immersive environment with wagering games, according to some example embodiments. The operations of a flowchart 700 are described in reference to FIGS. 1-6. The operations of the flowchart 700 begin at block 702.

At block 702, the game module 158 defines a number of locations in an online immersive environment, wherein each of the number of locations includes a number of wagering games for wagering game play. With reference to FIG. 1, the game module 158 can define the city A 102, the city B 104, the city C 106, the city D 108, the city E 110, the city F 112, the city X 114, the city Y 116, and the city Z 118. The game module 158 can define which wagering games are to be a part of the city, the types of leaderboards for the city, the types of times sold in the store for the city, the rule set for access to the city, wagering games in the city, the criteria for being selected as mayor, etc. Operations of the flowchart 700 continue at block 704.

At block 704, the game module 158 defines a number of paths between the number of locations in the online immersive environment. With reference to FIG. 1, the game module can define the different paths between the different cities—the path 130, the path 131, the path 132, the path 133, the path 134, the path 135, the path 136, the path 137, the path 138, and the path 139. The defining of the path includes defining a rule for access to the path. For example, the rule can require that the player satisfy a given criteria for wagering game play from their original city. For example, the player is required to satisfy a given criteria for wagering game play of a wagering game in the city C 106 prior to allowing the player to access the path 136 to go from the city C 106 to the city F 112. In some example embodiments, the rule can be based on satisfying criteria for wagering game play at a wagering game machine at a wagering game establishment. In some example embodiments, access to the path can require some type of social interaction with other players. Access to the path can also require interaction with real world product or services. For example, the player can be required to scan the bar code of product A using some type of bar code scanning device that is communicatively coupled to the player's account in the online immersive environment. In another example, the player is required to visit a wagering game establishment and checking in using their mobile device. Operations of the flowchart 700 continue at block 706.

At block 706, the game module 158 presents a different wagering game of the number of wagering games that is part of a location of the number of locations in the online immersive environment. With reference to FIG. 1, the game module 158 can present a wagering game that is defined for a city when the player is a resident of the city. This can be in response to a player being resident in the city and selecting a wagering game to play. Operations of the flowchart 700 continue at block 708.

At block 708, the game module 158 enables access to the wagering game of the number of wagering games in the location, in response to determining that wagering game play of the different wagering game satisfies the rule of the rule set that defines access to the wagering game. With reference to FIG. 1, the game module 158 enables access one wagering game based on wagering game play of a different wagering game. With reference to FIG. 1, the player 124 can be granted access to wagering game N 122 have wagering game play of the wagering game A 120 has satisfied certain criteria (e.g., triggering a bonus, obtaining a big win, obtaining a five of a kind, etc.). After access is granted, the player can be required to pay (using one or both of the currencies of the online immersive environment) to play the new wagering game. The access to a wagering game can also be granted based on other criteria. For example, access can be granted based on satisfying criteria for wagering game play at a wagering game machine at a wagering game establishment. In some example embodiments, access to the wagering game can require some type of social interaction with other players. Access to the wagering game can also require interaction with real world product or services. For example, the player can be required to scan the bar code of product A using some type of bar code scanning device that is communicatively coupled to the player's account in the online immersive environment. In another example, the player is required to visit a wagering game establishment and checking in using their mobile device. Operations of the flowchart 700 continue at block 710.

At block 710, the game module 158 selects the leader of the location based on the wagering game play of at least one of the number of wagering games at the location. The game module 158 can select the mayor based on rules in the rule set for the city. For example, a mayor can be based on a leader for game play (e.g., having the most points for all games, achieved the highest level for all games, achieved the highest level for a particular game, etc.). The mayor can be set for a given time period (e.g., one day, one week, etc.). After expiration of the time period, a new mayor is selected based on the unique rule set for the city. In some example embodiments, the mayor can define or adjust rules for the rule set for the city. The mayor of the city can also trigger events or allocate trophies or in-game prizes. The mayor can create tournaments of games in the city, special leaderboards, etc. Cities can also have multiple leaderboards (e.g., biggest win overall, longest winning streak, best bonus round, etc.). In some example embodiments, any player who is on any of the leaderboards has the possibility of being chosen to be a mayor for the city. Mayors can be randomly chosen from among the leaderboards periodically (e.g., daily, weekly, monthly, etc.). Also, mayors can be notified that they have been selected and the time period when their mayorship is active. Operations of the flowchart 700 are complete.

### Wagering Game Machine Architecture and Network Environment

This section describes an example wagering game architecture and network environment of some example embodiments.

### Wagering Game Machine Architecture

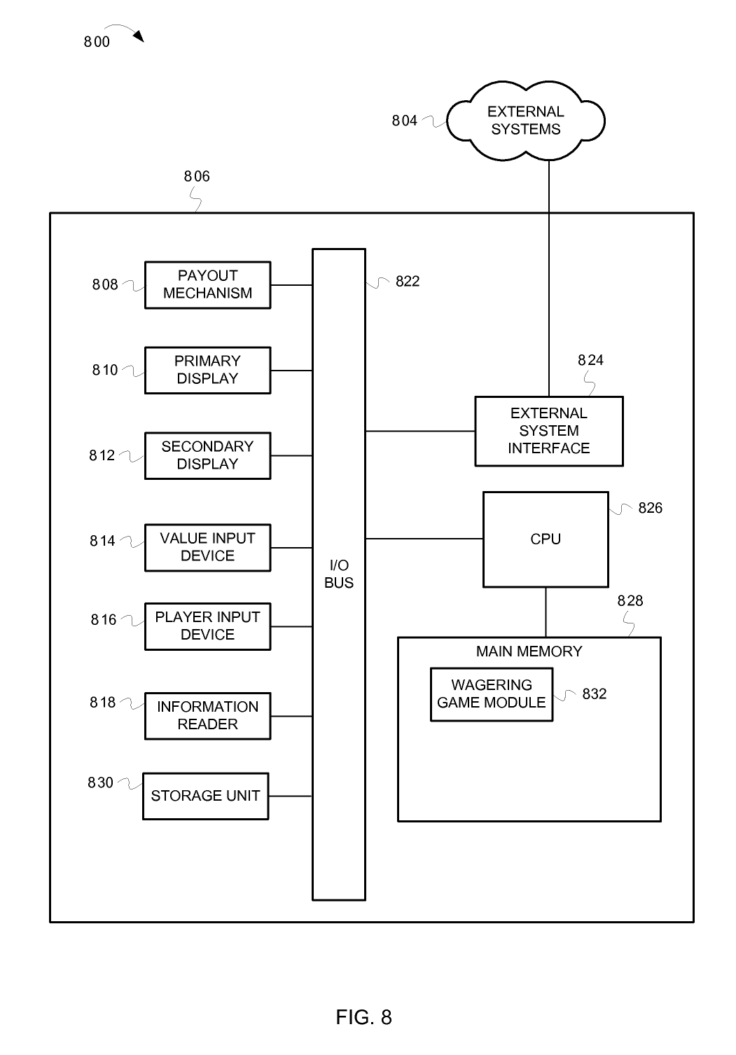

FIG. 8 is a block diagram illustrating a wagering game machine architecture, according to some example embodiments. As shown in FIG. 8, the wagering game machine architecture 800 includes a wagering game machine 806, which includes a central processing unit (CPU) 826 connected to main memory 828. The CPU 826 can include any suitable processor, such as an Intel® Pentium processor, Intel® Core 2 Duo processor, AMD Opteron™ processor, or UltraSPARC processor. The main memory 828 includes a wagering game unit 832. In one embodiment, the wagering game module 832 can present wagering games, such as video poker, video black jack, video slots, video lottery, etc., in whole or part. The wagering game module 832 can present wagering games that can be part of or associated with an online immersive environment (as described herein).

The CPU 826 is also connected to an input/output (I/O) bus 822, which can include any suitable bus technologies, such as an AGTL+frontside bus and a PCI backside bus. The I/O bus 822 is connected to a payout mechanism 808, primary display 810, secondary display 812, value input device 814, player input device 816, information reader 818, and storage unit 830. The player input device 816 can include the value input device 814 to the extent the player input device 816 is used to place wagers. The I/O bus 822 is also connected to an external system interface 824, which is connected to external systems 804 (e.g., wagering game networks).

In one embodiment, the wagering game machine 806 can include additional peripheral devices and/or more than one of each component shown in FIG. 8. For example, in one embodiment, the wagering game machine 806 can include multiple external system interfaces 824 and/or multiple CPUs 826. In one embodiment, any of the components can be integrated or subdivided.

Any component of the architecture 800 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 8 describes an example wagering game machine architecture, this section continues with a discussion an example wagering game network.

### Wagering Game Network

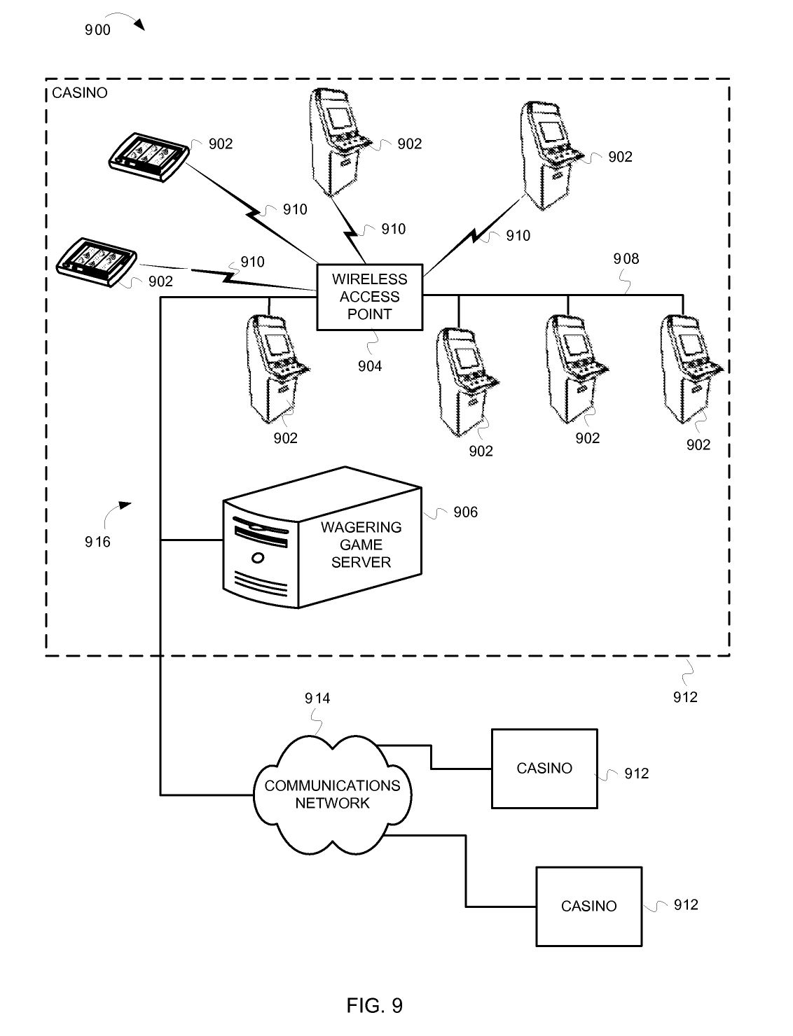

FIG. 9 is a block diagram illustrating a wagering game network 900, according to some example embodiments. As shown in FIG. 9, the wagering game network 900 includes a plurality of casinos 912 connected to a communications network 914.

Each casino 912 includes a local area network 916, which includes an access point 904, a wagering game server 906, and wagering game machines 902. The access point 9304 provides wireless communication links 910 and wired communication links 908. The wired and wireless communication links can employ any suitable connection technology, such as Bluetooth, 802.11, Ethernet, public switched telephone networks, SONET, etc. In some embodiments, the wagering game server 906 can serve wagering games and distribute content to devices located in other casinos 912 or at other locations on the communications network 914. In some example embodiments, the wagering game server 906 can host the game module that is providing the online immersive environment. Alternatively or in addition, the wagering game server 906 can be communicatively coupled to a different server that hosts the game module that is providing the online immersive environment.

The wagering game machines 902 described herein can take any suitable form, such as floor standing models, handheld mobile units, bartop models, workstation-type console models, etc. Further, the wagering game machines 902 can be primarily dedicated for use in conducting wagering games, or can include non-dedicated devices, such as mobile phones, personal digital assistants, personal computers, etc. In one embodiment, the wagering game network 900 can include other network devices, such as accounting servers, wide area progressive servers, player tracking servers, and/or other devices suitable for use in connection with embodiments of the invention.

In some embodiments, wagering game machines 902 and wagering game servers 906 work together such that a wagering game machine 902 can be operated as a thin, thick, or intermediate client. For example, one or more elements of game play may be controlled by the wagering game machine 902 (client) or the wagering game server 906 (server). Game play elements can include executable game code, lookup tables, configuration files, game outcome, audio or visual representations of the game, game assets or the like. In a thin-client example, the wagering game server 906 can perform functions such as determining game outcome or managing assets, while the wagering game machine 902 can present a graphical representation of such outcome or asset modification to the user (e.g., player). In a thick-client example, the wagering game machines 902 can determine game outcomes and communicate the outcomes to the wagering game server 906 for recording or managing a player's account.

In some embodiments, either the wagering game machines 902 (client) or the wagering game server 906 can provide functionality that is not directly related to game play. For example, account transactions and account rules may be managed centrally (e.g., by the wagering game server 906) or locally (e.g., by the wagering game machine 902). Other functionality not directly related to game play may include power management, presentation of advertising, software or firmware updates, system quality or security checks, etc.

Any of the wagering game network components (e.g., the wagering game machines 902) can include hardware and machine-readable media including instructions for performing the operations described herein.

### Example Wagering Game Machine

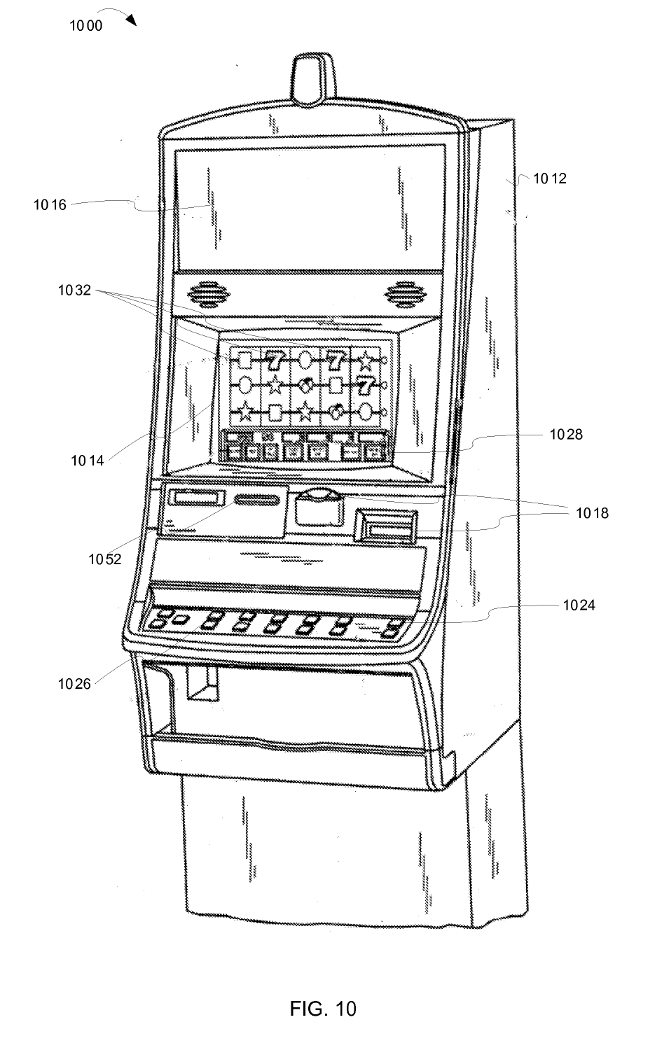

FIG. 10 is a perspective view of a wagering game machine, according to some example embodiments. Referring to FIG. 10, a wagering game machine 1000 is used in gaming establishments, such as casinos. According to embodiments, the wagering game machine 1000 can be any type of wagering game machine and can have varying structures and methods of operation. For example, the wagering game machine 1000 can be an electromechanical wagering game machine configured to play mechanical slots, or it can be an electronic wagering game machine configured to play video casino games, such as blackjack, slots, keno, poker, blackjack, roulette, etc.

The wagering game machine 1000 comprises a housing 1012 and includes input devices, including value input devices 1018 and a player input device 1024. For output, the wagering game machine 1000 includes a primary display 1014 for displaying information about a basic wagering game. The primary display 1014 can also display information about a bonus wagering game and a progressive wagering game. The wagering game machine 1000 also includes a secondary display 1016 for displaying wagering game events, wagering game outcomes, and/or signage information. While some components of the wagering game machine 1000 are described herein, numerous other elements can exist and can be used in any number or combination to create varying forms of the wagering game machine 1000.

The value input devices 1018 can take any suitable form and can be located on the front of the housing 1012. The value input devices 1018 can receive currency and/or credits inserted by a player. The value input devices 1018 can include coin acceptors for receiving coin currency and bill acceptors for receiving paper currency. Furthermore, the value input devices 1018 can include ticket readers or barcode scanners for reading information stored on vouchers, cards, or other tangible portable storage devices. The vouchers or cards can authorize access to central accounts, which can transfer money to the wagering game machine 1000.

The player input device 1024 comprises a plurality of push buttons on a button panel 1026 for operating the wagering game machine 1000. In addition, or alternatively, the player input device 1024 can comprise a touch screen 1028 mounted over the primary display 1014 and/or secondary display 1016.

The various components of the wagering game machine 1000 can be connected directly to, or contained within, the housing 1012. Alternatively, some of the wagering game machine's components can be located outside of the housing 1012, while being communicatively coupled with the wagering game machine 1000 using any suitable wired or wireless communication technology.

The operation of the basic wagering game can be displayed to the player on the primary display 1014. The primary display 1014 can also display a bonus game associated with the basic wagering game. The primary display 1014 can include a cathode ray tube (CRT), a high resolution liquid crystal display (LCD), a plasma display, light emitting diodes (LEDs), or any other type of display suitable for use in the wagering game machine 1000. Alternatively, the primary display 1014 can include a number of mechanical reels to display the outcome. In FIG. 10, the wagering game machine 1000 is an “upright” version in which the primary display 1014 is oriented vertically relative to the player. Alternatively, the wagering game machine can be a “slant-top” version in which the primary display 1014 is slanted at about a thirty-degree angle toward the player of the wagering game machine 1000. In yet another embodiment, the wagering game machine 1000 can exhibit any suitable form factor, such as a free standing model, bartop model, mobile handheld model, or workstation console model.

A player begins playing a basic wagering game by making a wager via the value input device 1018. The player can initiate play by using the player input device's buttons or touch screen 1028. The basic game can include arranging a plurality of symbols along a payline 1032, which indicates one or more outcomes of the basic game. Such outcomes can be randomly selected in response to player input. At least one of the outcomes, which can include any variation or combination of symbols, can trigger a bonus game.

In some embodiments, the wagering game machine 1000 can also include an information reader 1052, which can include a card reader, ticket reader, bar code scanner, RFID transceiver, or computer readable storage medium interface. In some embodiments, the information reader 1052 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
defining a number of locations in an online immersive environment, wherein each of the number of locations includes a number of games, wherein the defining includes defining a rule set for a location of the number of locations, wherein the rule set includes a rule that defines access to a game of the number of games, the access to the game based on game play of a different game of the number of games;
defining a number of paths between the number of locations in the online immersive environment, wherein the defining includes defining a rule for access to a path of the number of paths to travel between two locations of the number of locations;
presenting a different game of the number of games that is part of a location of the number of locations in the online immersive environment; and
enabling access to the game of the number of games in the location, in response to determining that game play of the different game satisfies the rule of the rule set that defines access to the game.

2. The method of claim 1, wherein the rule set includes a different rule that defines a leader of a location of the number of locations and is based on game play of at least one of the number of games at the location, wherein the method comprises:
selecting the leader of the location based on the game play of at least one of the number of games at the location

3. The method of claim 1, wherein at least one game of the number of games in the online immersive environment is associated with at least one wagering game machine at a wagering game establishment.

4. The method of claim 3, wherein the at least one game in the online immersive environment is a wagering game that is a scaled down version of a full version of a wagering game played on the at least one wagering game machine, the scaled down version having less game content than the full version.

5. The method of claim 1, wherein the rule set for a location is unique for the location relative to others of the number of locations.

6. A method comprising:
defining a number of locations in an online immersive environment, wherein each of the number of locations includes a number of wagering games for wagering game play, wherein the defining includes defining a rule set for a location, the rule set including a rule that defines access to a wagering game of the number of wagering games, wherein access to the wagering game is based on wagering game play of a wagering game machine at a wagering game establishment;
defining a number of paths between the number of locations in the online immersive environment, wherein the defining includes defining a rule for access to a path of the number of paths to travel between two locations of the number of locations;
presenting a different wagering game of the number of wagering games that is part of a location of the number of locations in the online immersive environment; and
enabling access to the wagering game of the number of wagering games in the location, in response to determining that wagering game play at the associated wagering game machine at the wagering game establishment satisfies the rule of the rule set that defines access to the wagering game; and
enabling access to the path that is from a first location to a second location of the number of locations, the access to the path based on wagering game play of a wagering game at the first location;

7. The method of claim 6, wherein the access to the path is based on wagering game play at a wagering machine at the wagering game establishment associated with the wagering game at the first location.

8. The method of claim 6, wherein the rule set includes a different rule that defines a leader of a location of the number of locations and is based on wagering game play of at least one of the number of wagering games at the location, wherein the method comprises:
selecting the leader of the location based on the wagering game play of at least one of the number of wagering games at the location

9. The method of claim 6, wherein at least one wagering game of the number of wagering games in the online immersive environment is associated with the wagering game machine at the wagering game establishment, wherein the at least one wagering game in the online immersive environment is a scaled down version of a full version of a wagering game played on the wagering game machine, the scaled down version having less game content than the full version.

10. The method of claim 6, wherein the rule set for a location is unique for the location relative to others of the number of locations.

11. One or more machine-readable storage media including instructions which, when executed by one or more processors, cause the one or more processors to perform operations comprising:
define a number of locations in an online immersive environment, wherein each of the number of locations includes a number of wagering games for wagering game play, wherein the define includes a define of a rule set for a location of the number of locations, wherein the rule set includes a rule that defines access to a wagering game of the number of wagering games, the access to the wagering game based on wagering game play of a different wagering game of the number of wagering games;
define a number of paths between the number of locations in the online immersive environment, wherein the define includes a define of a rule for access to a path of the number of paths to travel between two locations of the number of locations;
present a different wagering game of the number of wagering games that is part of a location of the number of locations in the online immersive environment; and
enable access to the wagering game of the number of wagering games in the location, in response to determining that wagering game play of the different wagering game satisfies the rule of the rule set that defines access to the wagering game.

12. The one or more machine-readable storage media of claim 11, wherein the rule set includes a different rule that defines a leader of a location of the number of locations and is based on wagering game play of at least one of the number of wagering games at the location, wherein the operations comprise:
select the leader of the location based on the wagering game play of at least one of the number of wagering games at the location

13. The one or more machine-readable storage media of claim 11, wherein at least one wagering game of the number of wagering games in the online immersive environment is associated with at least one wagering game machine at a wagering game establishment.

14. The one or more machine-readable storage media of claim 13, wherein the at least one wagering game in the online immersive environment is a scaled down version of a full version of a wagering game played on the at least one wagering game machine, the scaled down version having less game content than the full version.

15. The one or more machine-readable storage media of claim 11, wherein the rule set for a location is unique for the location relative to others of the number of locations.

16. An apparatus comprising:
a processor;
a game module executable on the processor, the game module configured to,
define a number of locations in an online immersive environment, wherein each of the number of locations includes a number of wagering games for wagering game play, wherein the define includes a define a rule set for a location, the rule set including a rule that defines access to a wagering game of the number of wagering games, wherein access to the wagering game is based on wagering game play of a wagering game machine at a wagering game establishment;
define a number of paths between the number of locations in the online immersive environment, wherein the define includes a define a rule for access to a path of the number of paths to travel between two locations of the number of locations;
present a different wagering game of the number of wagering games that is part of a location of the number of locations in the online immersive environment; and
enable access to the wagering game of the number of wagering games in the location, in response to determining that wagering game play at the associated wagering game machine at the wagering game establishment satisfies the rule of the rule set that defines access to the wagering game; and
enable access to the path that is from a first location to a second location of the number of locations, the access to the path based on wagering game play of a wagering game at the first location;

17. The apparatus of claim 16, wherein the access to the path is based on wagering game play at a wagering machine at the wagering game establishment associated with the wagering game at the first location.

18. The apparatus of claim 16, wherein the rule set includes a different rule that defines a leader of a location of the number of locations and is based on wagering game play of at least one of the number of wagering games at the location, wherein the game module is configured to,
select the leader of the location based on the wagering game play of at least one of the number of wagering games at the location

19. The apparatus of claim 16, wherein at least one wagering game of the number of wagering games in the online immersive environment is associated with the wagering game machine at the wagering game establishment, wherein the at least one wagering game in the online immersive environment is a scaled down version of a full version of a wagering game played on the wagering game machine, the scaled down version having less game content than the full version.

20. The method of claim 16, wherein the rule set for a location is unique for the location relative to others of the number of locations.

21. An apparatus comprising:
means for defining a number of locations in an online immersive environment, wherein each of the number of locations includes a number of wagering games for wagering game play, wherein the means for defining includes means for defining a rule set for a location of the number of locations, wherein the rule set includes a rule that defines access to a wagering game of the number of wagering games, the access to the wagering game based on wagering game play of a different wagering game of the number of wagering games;
means for defining a number of paths between the number of locations in the online immersive environment, wherein the means for defining includes means for defining a rule for access to a path of the number of paths to travel between two locations of the number of locations;
means for presenting a different wagering game of the number of wagering games that is part of a location of the number of locations in the online immersive environment; and
means for enabling access to the wagering game of the number of wagering games in the location, in response to determining that wagering game play of the different wagering game satisfies the rule of the rule set that defines access to the wagering game.

22. The apparatus of claim 21, wherein the rule set includes a different rule that defines a leader of a location of the number of locations and is based on wagering game play of at least one of the number of wagering games at the location, wherein the apparatus comprises:
means for selecting the leader of the location based on the wagering game play of at least one of the number of wagering games at the location

23. The apparatus of claim 21, wherein at least one wagering game of the number of wagering games in the online immersive environment is associated with at least one wagering game machine at a wagering game establishment.

24. The apparatus of claim 23, wherein the at least one wagering game in the online immersive environment is a scaled down version of a full version of a wagering game played on the at least one wagering game machine, the scaled down version having less game content than the full version.

25. The apparatus of claim 21, wherein the rule set for a location is unique for the location relative to others of the number of locations.
